(19) United States
(12) Patent Application Publication
(10) Pub. No.: US 2019/0065333 A1
(43) Pub. Date: Feb. 28, 2019

(54) COMPUTING SYSTEMS AND METHODS WITH FUNCTIONALITIES OF PERFORMANCE MONITORING OF THE UNDERLYING INFRASTRUCTURE IN LARGE EMULATED SYSTEM

(71) Applicant: Unisys Corporation, Blue Bell, PA (US)

(72) Inventors: Thomas L. Nowatzki, Roseville, MN (US); E. Brian Garrett, Salt Lake City, UT (US); Michael J. Rieschl, Roseville, MN (US); Marwan A. Orfali, Roseville, MN (US)

(21) Appl. No.: 15/684,216

(22) Filed: Aug. 23, 2017

(51) Int. Cl. G06F 11/30; G06F 9/30

(52) U.S. Cl. CPC G06F 11/3051; G06F 9/3017

(57) ABSTRACT

A computing system configured to optimize computing resources distribution includes a hardware platform which includes a physical instruction processor (IP); a kernel structure executed on the hardware platform which includes an emulated IP; an emulated operating system executed on the kernel structure; and a performance monitor executed on the emulated operating system. The performance monitor interrogates the emulated IP to obtain performance information which includes a time of executing an instruction at the kernel structure; a time of executing an instruction at an application software level; bytes received by the emulated IP through a networking interface; and bytes transmitted by the emulated IP through the networking interface.

### FIELD OF THE DISCLOSURE

The instant disclosure relates generally to increasing the processing speed of computing systems by optimizing the computing resource distributions. More specifically, this disclosure relates to embodiments of mainframe systems and methods with advanced functionalities of performance monitoring of the underlying infrastructure in large emulated system.

### BACKGROUND

In a computing system, especially commodity-type computing systems, it is difficult to identify performance bottlenecks. Often, commodity-type computing systems are low cost systems customized with baseline designs.

It is difficult to optimize such baseline commodity-type computing systems because the instruction processor of such systems do not provide any statistical information. Currently, the statistical information package for commodity-type computing systems is being assembled from information obtained from the execution of an instruction processor. However, this information from the instruction processor does not include any statistical information from the underlying commodity system.

Embodiments disclosed herein are designed to improve the optimization of computing systems by providing statistical information about the underlying commodity system.

### SUMMARY

The instant disclosure relates generally to increasing the processing speed of computing systems by optimizing the computing resource distributions. More specifically, this disclosure relates to embodiments of mainframe systems and methods with advanced functionalities of performance monitoring of the underlying infrastructure in large emulated system.

According to one embodiment of the disclosure a computing system configured to optimize computing resources distribution, comprising a hardware platform, the hardware platform including a physical instruction processor (IP); a kernel structure executed on the hardware platform, the kernel structure including an emulated IP; an emulated operating system executed on the kernel structure; and a performance monitor executed on the emulated operating system; wherein the performance monitor interrogates the emulated IP to obtain performance information, the performance information including a time of executing an instruction at the kernel structure; a time of executing an instruction at an application software level; bytes received by the emulated IP through a networking interface; bytes transmitted by the emulated IP through the networking interface; bytes transmitted by the emulated IP through the kernel disk subsystem; and the state of the kernel virtual memory.

According to one embodiment of the disclosure, a computer program product configured to optimize computing resources distribution, comprising a hardware platform, the hardware platform including a physical instruction processor (IP) and a non-transitory computer-readable medium; a kernel structure executed on the hardware platform, the kernel structure including an emulated IP; and an emulated operating system executed on the kernel structure; and the non-transitory computer-readable medium comprising instructions which, when executed by the emulated IP, cause the emulated IP to send performance information to the computer program, the performance information including a time of executing an instruction at the kernel structure; a time of executing an instruction at an application software level; bytes received by the emulated IP through a networking interface; bytes transmitted by the emulated IP through the networking interface; bytes transmitted by the emulated IP through the kernel disk subsystem; and the state of the kernel virtual memory.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the concepts and specific embodiments disclosed may be readily utilized as a basis for modifying or designing other structures for carrying the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed systems and methods, reference is now made to the following descriptions taken in conjunction with the accompanying drawings.

FIG. 1 shows a computing system according to one embodiment of the disclosure.

FIG. 2 shows a computing system with performance monitoring according to one embodiment of the disclosure.

FIG. 3 shows a computing system according to one embodiment of the disclosure.

FIG. 4 shows a block diagram of a computing system according to one embodiment of the disclosure.

FIG. 5 shows a computing system according to one embodiment of the disclosure.

FIG. 6 shows an SSIP instruction according to one embodiment of the disclosure.

FIG. 7 shows an SSAIL instruction according to one embodiment of the disclosure.

FIG. 8A shows the detail of an SSAIL instruction memory layout according to one embodiment of the disclosure.

FIG. 8B shows the detail of an SSAIL instruction memory layout according to one embodiment of the disclosure.

FIG. 9 illustrates a computer network for obtaining access to database files in a computing system according to one embodiment of the disclosure.

FIG. 10 illustrates a commodity-type computer system adapted for the embodiments of the disclosure.

FIG. 11A shows a block diagram illustrating a server hosting an emulated software environment for virtualization according to one embodiment of the disclosure.

FIG. 11B shows a block diagram illustrating a server hosting an emulated hardware environment according to one embodiment of the disclosure.

FIG. 12 shows a process 1200 of collecting information of a common log entry 1225 according to one embodiment of the disclosure.

### DETAILED DESCRIPTION

The existence of the underlying commodity system is largely ignored by users. A user is asked to an operating system (OS), for example, OS2200 system. The user is only skilled in operating the OS. The user is not expected to execute applications directly on the commodity system to gather statistics that can be used for performance, sizing, and optimization. The OS is always controlling the underlying commodity system. The OS, e.g., OS2200, can be emulated systems.

In one embodiment, the commodity system contains new types of statistics that need to be gathered. The types of statistics needed include statistics about all instruction processors (IPs), e.g., physical CPUs, emulated IPs. Although a commodity CPU is bound to an OS, there are additional CPUs that control other activities, such as networking, and memory paging or clearing. The processing statistics for these additional CPUs need to be obtained. For example, memory is being controlled by the commodity system. Statistics describing the percentages of memory that is being used, paged, or cleared needs to be obtained.

In some embodiments, the computing system includes a plurality of emulated IPs, and each of the emulated IPs is dedicated to one specific task, e.g., CPU utilization, networking, context switching, memory management, swap, paging, data input/output, etc. Specific statistic information can be obtained from the specific IP dedicated to the specific task.

In another embodiment, networking is being controlled by the commodity system through an IP separate from the main IP that operates the OS. In another embodiment, networking statistics are obtained directly from the IP that controls the networking.

In one specific embodiment, the computing system integrates the performance data from the computing system operating with OS (e.g., OS 2200) with the performance data obtained from the underlying commodity system.

In one embodiment, the OS interrogates the underlying commodity system at the physical IP level and/or the emulated IP level and/or kernel level and/or the software application level when the existing performance analysis package is executed. The interrogation by the OS includes sending requests to and obtaining data from the underlying commodity system. The interrogation by the OS also includes sending requests to and obtaining data from the IP in interest. Thus, the OS is in control of all performance monitoring.

In one embodiment, the computing system instruction processor provides a machine executable instruction that can be called by the OS to fill a fixed size nontransient memory partition, e.g., a buffer, with the underlying commodity system performance information.

In one embodiment, the statistical data that is being gathered is integrated into the existing performance monitoring data file. Thus, there is only a single output file that contains all of the performance data. In another embodiment, the existing application sets of an OS, e.g., OS 2200, performance monitor tools are updated to extract and process the new statistical data from the performance data file.

In one embodiment, the computing system, e.g., commodity system, may adjust runs and activities depending upon the data. For example, if memory is being paged, the computing system may suspend the start of new runs or activities until the performance is within acceptable limits.

In another embodiment, the performance statistic data can be used to analyze and predict future system size requirements of the underlying commodity system as the customer's needs dictate. This analysis data can be used for sizing of computing systems as the workload changes and/or for consolidating systems.

In some embodiments, there are software applications that are controlled by large mainframe systems with Complementary metal-oxide semiconductor (CMOS) instruction processors that execute upon these systems. In other embodiments, the CMOS processor are replaced by emulated IPs. To replace CMOS processor to emulated IPs, management of memory management and networking move down one level into the underlying commodity system. In other embodiments, the computing system combines the performance information with the additional commodity performance information into a single existing performance analysis package.

The “computing system” disclosed in this specification includes, but is not limited to, mainframe computing system, personal use computing system (e.g., Intel CPU based personal computer), industrial use computing system, commodity type computing systems, etc.

The term “instruction” means an instruction processor-executable instruction, for example, an instruction written as programming codes. An instruction may be executed by any suitable processor, for example, x86 processor, an emulated processor. An instruction may be programed in any suitable computer language, for example, machine codes, assembly language codes, C language codes, C++ language codes, Fortran codes, Java codes, Matlab codes, or the like. All methods, software and emulated hardware disclosed in this disclosure can be implemented as instructions.

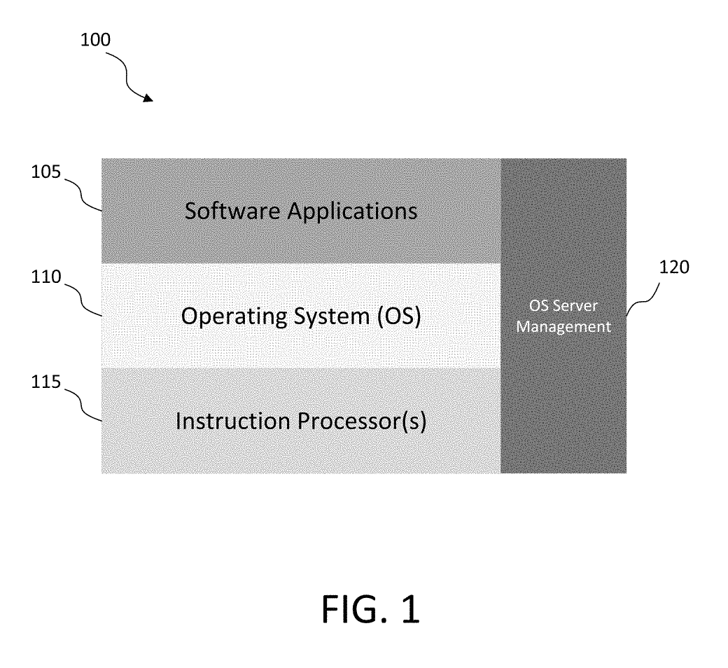

FIG. 1 shows a computing system 100 according to one embodiment. The computing system 100 includes software applications 105, operating system (OS) 110, instruction processors (IPs) 115, and OS server management 120.

Software applications 105 require a large degree of data security and recoverability. Software applications 105 are supported by mainframe data processing systems. Software applications 105 may be configured for utility, transportation, finance, government, and military installations and infrastructures. Such applications 105 are generally supported by mainframe systems because mainframes provide a large degree of data redundancy, enhanced data recoverability features, and sophisticated data security features. These mainframe systems were generally manufactured with a proprietary CMOS chip se. In one embodiment, the computing system 100 is a main frame data processing system.

The OS server management 120 monitors the performances at all levels, including software applications 105, the operating system 110, and instruction processors 115. In one embodiment, the OS server management 120 collects statistical data directly from the instruction processors 115.

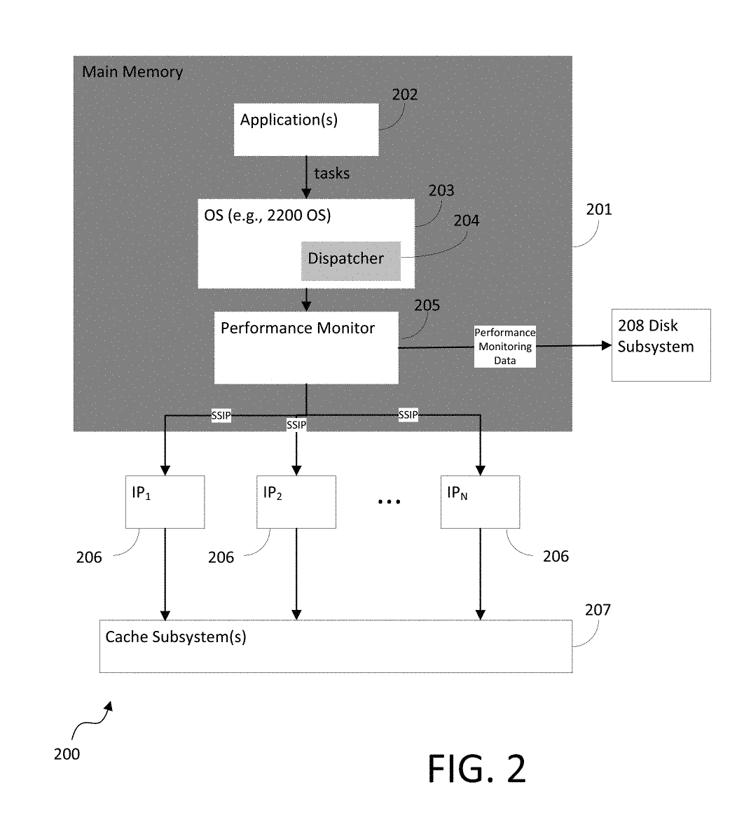

FIG. 2 shows a computing system 200 with performance monitoring according to one embodiment. In one embodiment, the computing system 200 can be the computing system 100 shown in FIG. 1.

In one embodiment, computing system 200 shows a block diagram illustrating an example of a conventional CMOS proprietary multiprocessor system having an OS 203 that includes a dispatcher 204 for assigning tasks with one of the IPs 206. The computing system 200 includes a main memory 201, a plurality of instruction processors (IPs) 206, and cache subsystem(s) 207. OS 203 is, in this example, adapted to execute directly on the computing system's IPs 206, and thus has direct control over management of the task assignment among such IPs 206.

In one example, computing system 200 provides a platform on which OS 203 executes, where such platform is an enterprise-level platform, such as a mainframe, that typically provides the data protection and recovery mechanisms needed for application programs that are manipulating critical data and/or must have a long mean time between failures. In one exemplary embodiment, the OS 203 is the 2200 OS and an exemplary platform is a legacy 2200 mainframe data processing system, each commercially available from the UNISYS® Corporation. Alternatively, the legacy OS 203 may be some other type of OS, and the legacy platform may be some other enterprise-type environment.

Application programs (APs) 202 communicate directly with OS 203. These APs may be of a type that is adapted to execute directly on a legacy platform. APs 202 may be, for example, those types of application programs that require enhanced data protection, security, and recoverability features generally only available on legacy mainframe platforms.

The OS 203 performs performance monitoring by executing a performance monitor software 205. This performance monitor software 205 executes the Store the Software Instruction package instruction (SSIP) through the IPs 206. The package includes statistics about cycle counts, instruction counts, and interrupt counts. The performance monitor package gathers the performance data from all instruction processors, formats the data, and packages the data into a date file on the disk subsystem 208. Paging statistics are gathered from the operating system's one paging mechanism and are also included in the data file.

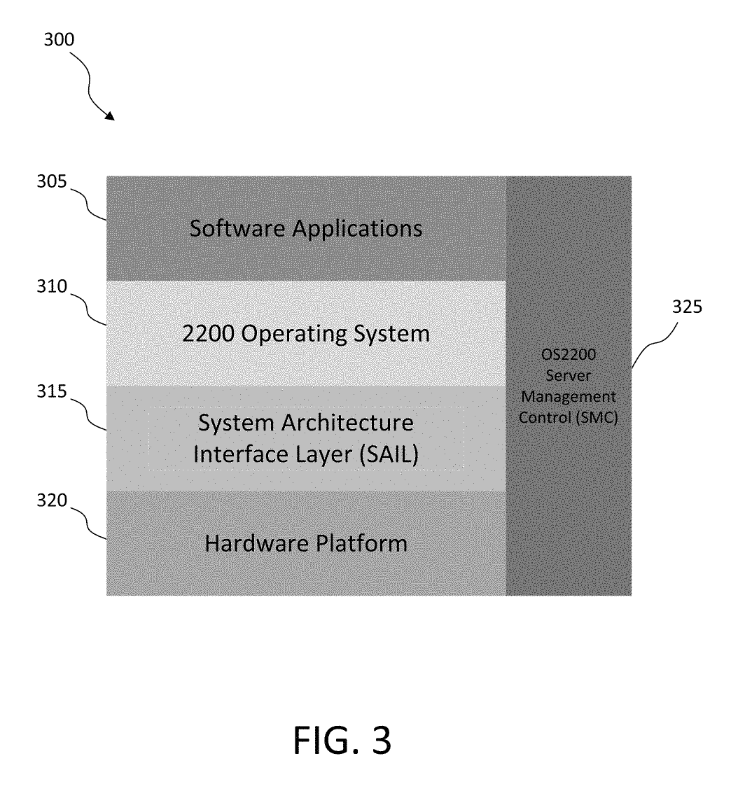

FIG. 3 shows a computing system 300 according to one embodiment. The computing system 300 may be the computing system 100 as shown in FIG. 1. The computing system 300 can be the computing system 200 as shown in FIG. 2.

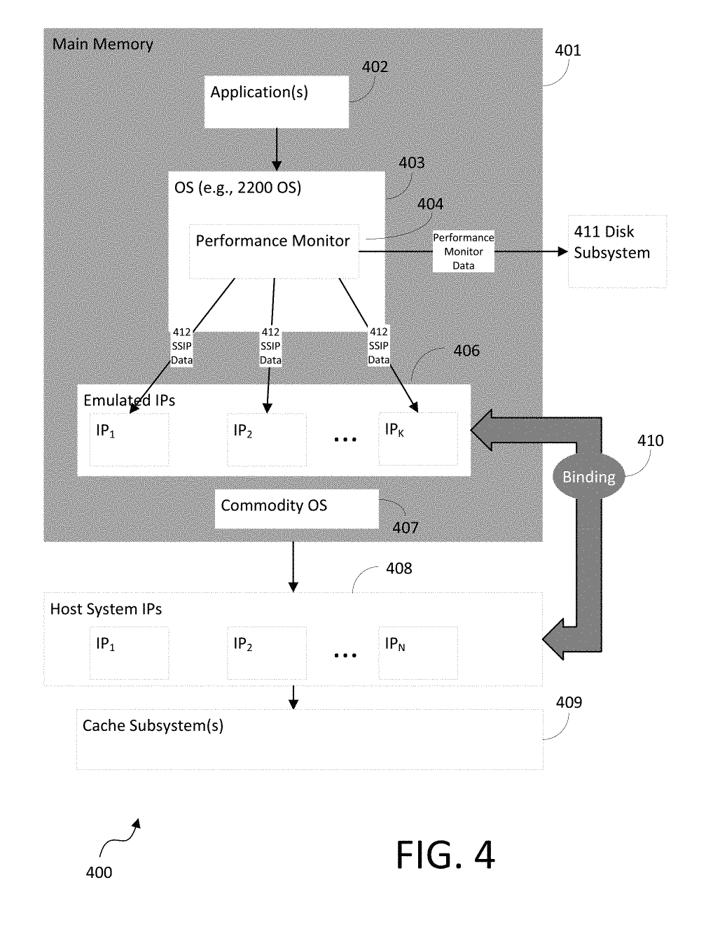

FIG. 3 shows as example of an OS, (e.g., OS 403 in FIG. 4) that may be implemented in an emulated processing environment. The emulated OS 2200 mainframe operating system available from UNISYS® Corp. may be so implemented. A high-level block diagram of an Emulated OS 2200 310 mainframe architecture is shown in FIG. 3. In FIG. 3, the System Architecture Interface Layer (SAIL) 315 is the kernel structure between the OS 2200 310 and the commodity (e.g., INTEL processor platform) hardware platform 320.

The SAIL software package 315 includes the following components: SAIL Kernel—SUSE Linux Enterprise Server distribution with open source modifications; System Control (SysCon)—The glue that creates and controls the instruction processor emulators; 2200 Instruction Processor emulator—based on 2200 ASA-00108 architecture; Network emulators; and Standard Channel Input/output processor (IOP) drivers.

Software applications 305 require a large degree of data security and recoverability. Software applications 305 are supported by mainframe data processing systems. Software applications 305 may be configured for utility, transportation, finance, government, and military installations and infrastructures. Such applications 305 are generally supported by mainframe systems because mainframes provide a large degree of data redundancy, enhanced data recoverability features, and sophisticated data security features. In one embodiment, the computing system 300 is a main frame data processing system.

The hardware platform 320 is, in one exemplary implementation, a DELL® server with associated storage input/output processors, host bus adapters, host adapters, and network interface cards. While the above-mentioned Dell hardware platform is used as an example herein for describing one illustrative implementation, embodiments of the present invention are not limited to any particular host system or hardware platform but may instead be adapted for application with any underlying host system.

The OS 2200 server management control (SMC) 325 monitors the performance at all level of the computing system, including softwares 305, 2200 OS 310, SAIL 315, and hardware platform 320.

As discussed above, in an OS (e,g., OS 2200) CMOS systems, such as that illustrated in FIGS. 1-2, the OS controls the IPs directly. However, in emulated systems (e.g., where IPs are emulated on a host system), such as in the example of FIGS. 3-4, the System Architecture Interface Level (“SAIL”) (Linux) controls what 2200 IP executed on what underlying host system's IPs (e.g., Intel core(s)).

FIG. 4 shows a block diagram of a computing system 400 according to one embodiment of the disclosure. The computing system 400 may be the computing system 100 of FIG. 1. The computing system 400 may be the computing system 200 of FIG. 2. The computing system 400 may be the computing system 300 of FIG. 3.

In FIG. 4, an OS 403 (e.g., a legacy OS) is executing on emulated IPs 406 for supporting execution of application programs 402. Also included is a native host (e.g., “commodity”) OS 407 that runs directly on the host system's IPs 408. The system also includes cache subsystem 409. The emulated instruction processors 406 are bound to the physical instruction processors 410. In one embodiment, one emulated IP 406 is bound to one physical IP 410 so that one emulated IP 406 is executed on one physical IP 410. In another embodiment, one physical IP 410 may split its processing power and execute two or more emulated IPs 406.

In FIG. 4, the performance monitor 404 executes in the same manner as it did in the CMOS system with some potential limitations. The direct instruction cycle counts of the emulated IPs 406 may not be meaningful. To make the instruction cycle counts of the emulated IPs meaningful, a calculation is done to count how many proprietary instructions (executed under emulated OS 403) are executed on the emulated IPs 406 and how many native instructions on the physical IP 408 are required to execute these proprietary instructions. The number of native instructions required on the physical IP 408 gives the meaningful monitoring of the consumption of the computing resources.

In one embodiment, the instruction counts are still provided by the emulator, however, to make the counts meaningful they need to be calculated depending on how many proprietary instructions are being emulated within a block of Intel instructions. In one embodiment, different compilers allow for bunches of proprietary instructions to be compiled into a block of Intel instructions. In one embodiment, the compiler can translate the counts of proprietary instructions for emulated IP 406 to the counts of instructions for physical IPs 410. In another embodiment, the interrupt counts for the emulated IPs 406 are provided by the emulator.

When combining FIG. 3 and FIG. 4, the proprietary paging software (e.g., applications 305, 402) and hardware instructions is removed. The responsibility for paging is lowered one level down from the emulated OS (e.g., 310, 403) to the SAIL kernel 315. The proprietary emulated OS (e.g., 310, 403) requests chunks of memory to be used with its banking structures. All paging activities are hidden from the proprietary emulated OS (e.g., 310, 403).

There is software available that will provide a performance monitor for a commodity system, but that cannot be used within this implementation. When a customer buys an emulated system they expect to operate the system from one interface. The existence of an additional embedded operating system may not be desirable. The monitoring information can be provided from the mainframe system.

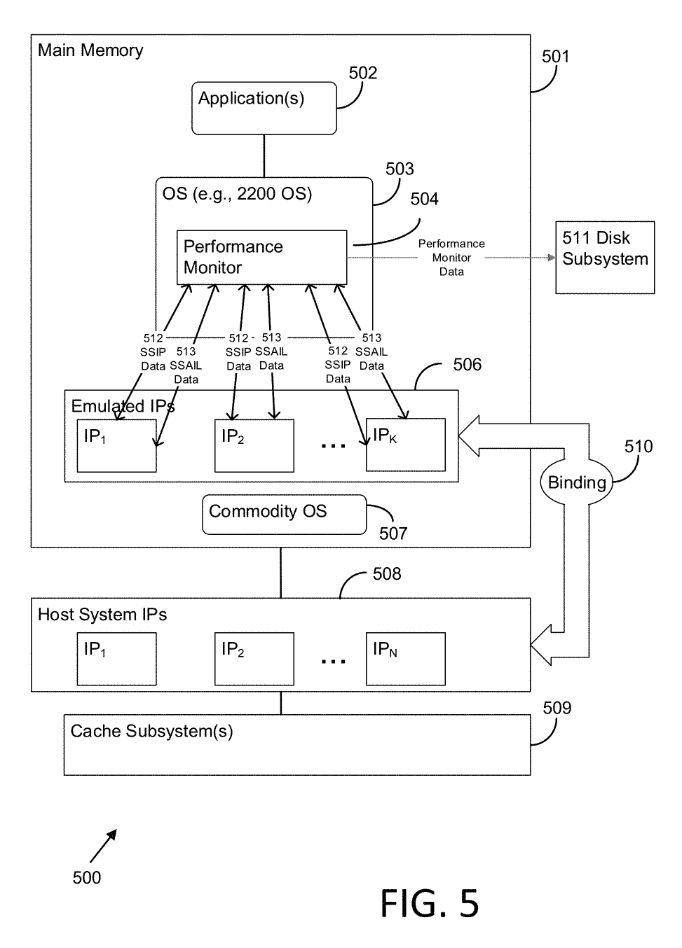

FIG. 5 shows a computing system 500 according to one embodiment of the disclosure. The computing system 500 can be the computing system 100 of FIG. 1. The computing system 500 can be the computing system 200 of FIG. 2. The computing system 500 can be the computing system 300 of FIG. 3. The computing system 500 can be the computing system 400 of FIG. 4.

The computing system 500 includes main memory 501, applications 502, emulated OS 503, performance monitor 504 executed on the kernel structures (e.g., SAIL) supporting the emulated OS 503, emulated IPs 506, commodity OS 507, physical IPs 508, and cache subsystem 509, and disk subsystem 511, wherein the emulated IPs 506 are bounded 510 to physical IPs 508.

In FIG. 5, the mainframe operating system 503 will execute an IP instruction, SSAIL (Store System Architecture Interface Layer), to collect the new SAIL (System Architecture interface Layer) data during normal SIP (Software Instruction Package) data collection. The performance monitor 504 then does a short wait for each IP to report in.

The additional SSAIL log entries are included with the existing SIP statistic blocks and written to the standard SIP file. In other words, the SSAIL log entries are integrated into a single file with the SSIP entries.

The emulated IPs 506 support the OS2200 IP instruction SSAIL. One of the existing IP threads, within the commodity OS 507, will be changed to extract the SAIL system statistics on the existing sampling interval and will populate a fixed sized data structure. This data is read in-line by the OS2200 IP by issuing the new IP instruction SSAIL.

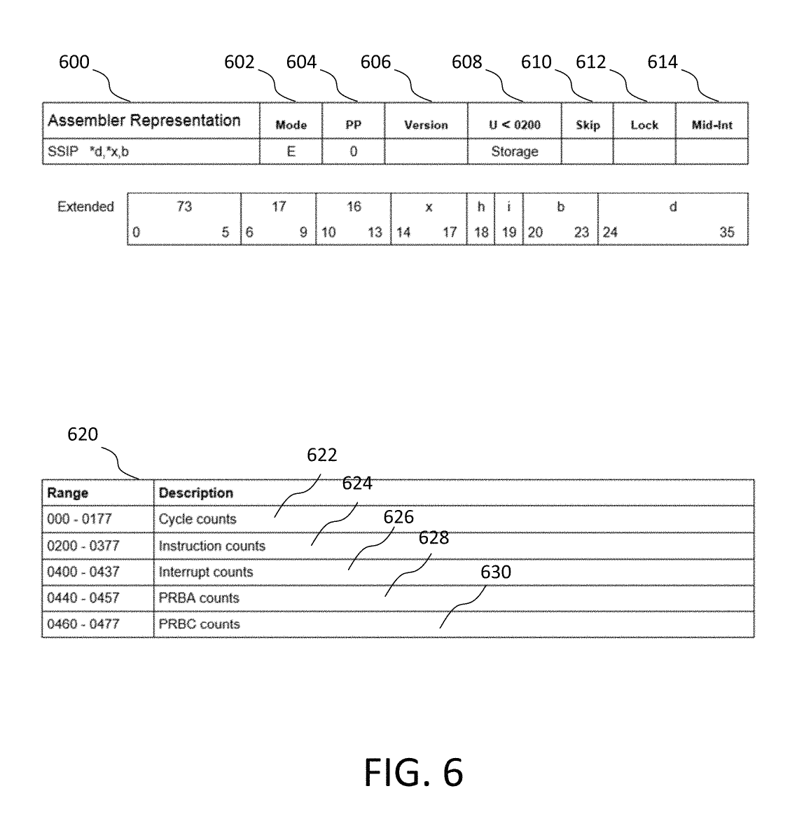

FIG. 6 shows an SSIP instruction 600 according to one embodiment of the disclosure. The SSIP instruction 600 stores the SIP (Software Instrumentation Package) data in storage starting at the instruction operand address, U. Storing continues, with X incremented for each word stored, until all SIP data has been stored. SSIP then reinitializes the hard held SIP data.

As shown in FIG. 6, SSIP includes parameters: d, x, b. Parameter “d” represents an Extended_Mode operand address, such as program label TAG. Parameter “x” represents register mnemonic, such as X9. Parameter “b” represents an Extended_Mode Base_Register mnemonic, such as B6. The asterisk “*” represents the assembled instruction F0.i=1. An asterisk preceding the X- register specification indicates X-Register increment and the F0.h=1. If Immediate_Operand addressing is indicated by a partial-word mnemonic of U or XU and the X-Register specification is not present, then neither of these asterisks can be present and the operand address specification can be up to 18 bits long.

“Mode” 602 indicates the instruction execution mode (Mode) column of the instruction description table indicates whether the instruction is an Extended_Mode (E) or Basic_Mode (B) Mode. Instruction execution mode is controlled by Designator Bit 16 (DB16).

“PP” 604 indicates the Processor Privilege (PP) column in each subsection represents the Processor Privilege needed to execute the indicated instruction. If this table column is blank, the instruction can be executed in any PP. PP is controlled by DB14 and DB15 (see 2.2.2).

“Version” 606 indicates the Version column indicates the Version of the architecture that supports that particular instruction.

“U<0200” 608 indicates where the operand is found when the operand address is U<0200 (see 4.4.2.4), the General Register Set (GRS), storage, or Architecturally_Undefined.

“Skip” 610 indicates that the instruction could potentially skip the next instruction.

“Lock” 612 indicates that the instruction is executed under Storage_Lock.

“Mid-Interrupts (Mid-Int)” 614 indicates the instruction potentially has mid-execution interrupt points.

The SSIP instruction stores the SIP (Software Instrumentation Package) data in storage starting at the instruction operand address, U. Storing continues, with Xx incremented for each word stored, until all SIP data has been stored. SSIP then reinitializes the hard-held SIP data.

The SSIP instruction writes the packet 620 to memory starting at U and all counts to zero. The packet 620 has a memory layout as shown in FIG. 6.

“Cycle count” 622 indicates the number of cycles (divided by 41) that were executed since the last SSIP instruction was executed.

In another embodiment, “cycle count” 622 indicates the relative time spent in each category since the last SSIP instruction was executed. The cycle count (relative time spent in each category) values can only be compared to other values within this table.

“Instruction count” 624 indicates the number of instructions (divided by 41) that were executed since the last SSIP instruction was executed.

“Interrupt count” 626 indicates the number of interrupts that have been taken since the last execution of the SSIP instruction.

“PRBA count” 628 indicates the number of PRBAs that have been executed since the last execution of the SSIP instruction. PRBA is probe A, an instruction that provides a signal to the performance monitor (e.g., 504).

“PRBC count” 630 indicates the number of PRBCs that have been executed since the last execution of the SSIP instruction. PRBC is probe C, an instruction that provides a signal to the performance monitor (e.g., 504).

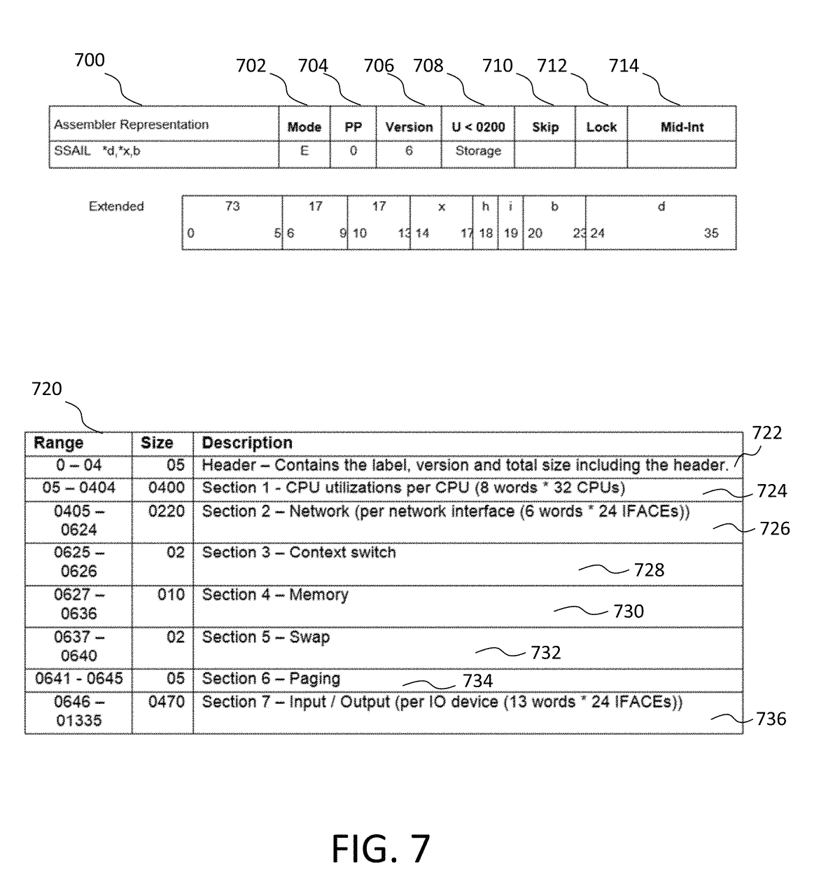

FIG. 7 shows an SSAIL instruction 700 according to one embodiment of the disclosure. The SSAIL instruction 700 stores the SAIL data in storage starting at the instruction operand address, U. Storing continues, with X incremented for each word stored, until all SAIL data has been stored. SSAIL does not reinitialize the hard-held SAIL data.

The instruction SSAIL 700 includes parameters: d, x, b. Parameter “d” represents an Extended_Mode operand address, such as program label TAG. Parameter “x” represents register mnemonic, such as X9. Parameter “b” represents an Extended_Mode Base_Register mnemonic, such as B6. The asterisk “*” represents the assembled instruction F0.i=1. An asterisk preceding the X- register specification indicates X-Register increment and the F0.h=1. If Immediate_Operand addressing is indicated by a partial-word mnemonic of U or XU and the X-Register specification is not present, then neither of these asterisks can be present and the operand address specification can be up to 18 bits long.

Mode 702 has the same meaning as Mode 602. PP 704 has the same meaning as PP 604. Version 706 has the same meaning as Version 606. U<0200 708 has the same meaning as U<0200 608. Skip 710 has the same meaning as Skip 610. Lock 712 has the same meaning as Lock 612. Mid-int 714 has the same meaning as Mid-int 614.

The SSAIL instruction 700 writes the packet 720 to the memory. The packet 720 includes header 722, section 1 724, section 2 726, section 3 728, section 4 730, section 5 732, section 6 734, and section 7 736.

In one embodiment, the computing system includes a plurality of emulated IPs. During performance monitoring, the SSIP instruction is executed on each emulated IP. Once all IPs have reported, the SSAIL instruction must be executed on the last instruction processor reporting SSIP information. Thus the SSIP data for each instruction processor followed with one block of SSAIL information is packaged into one log entry.

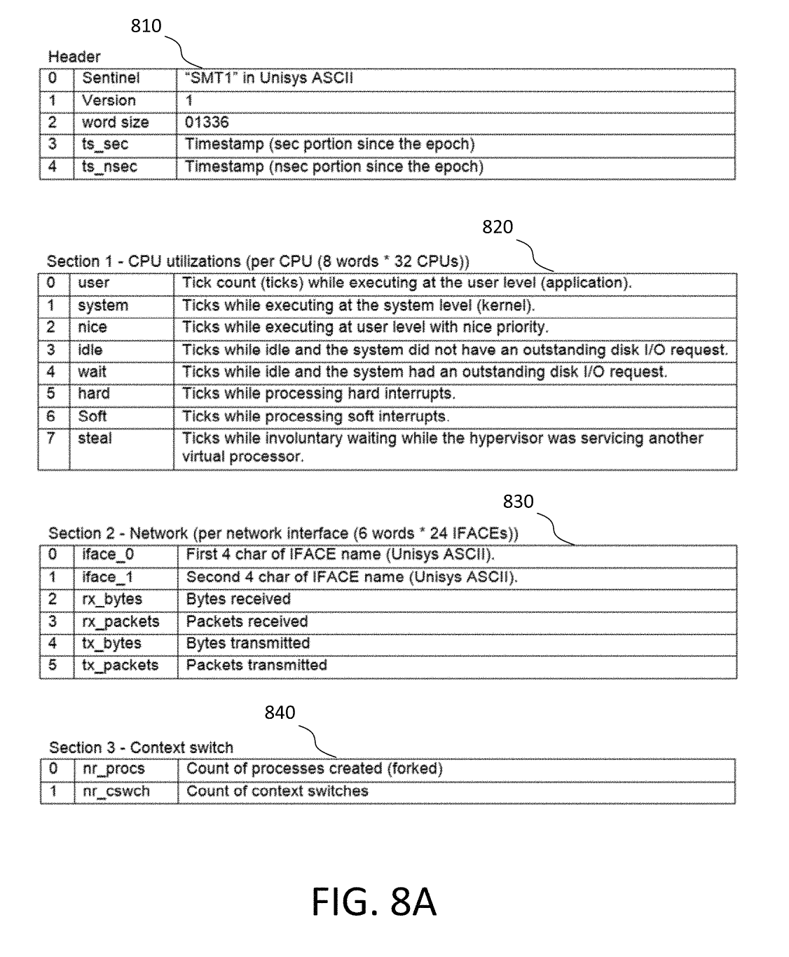

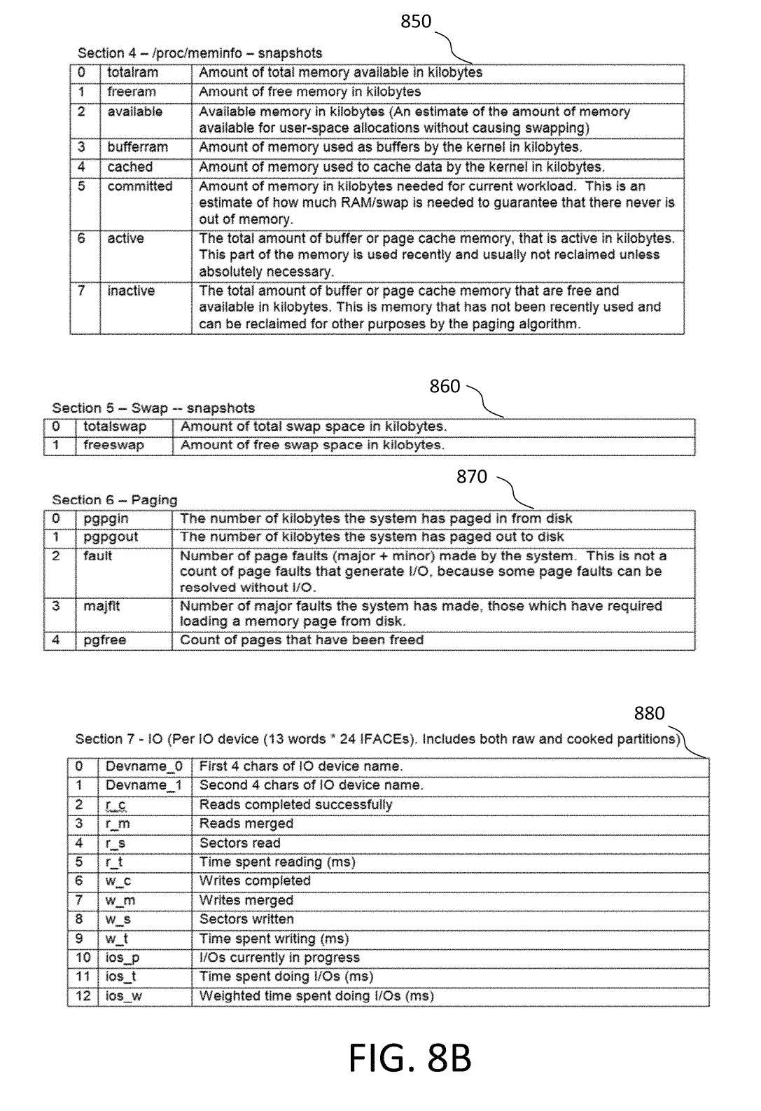

The header 722 is shown in detail in 810 of FIG. 8A. As shown in FIG. 8A, the 810 includes sentinel, version, word size, ts_sec, and ts_nsec.

The Section 1 724 is shown in detail in 820 of FIG. 8A. As shown in FIG. 8A, the Section 1 820 relates to information about CPU utilizations. Section 1 820 includes tick count while executing that the user level (application level); ticks while executing at the system level (kernel level); ticks while executing at user level with nice priority; ticks while idle and the system did not have an outstanding disk input/output request; ticks while idle and the system had an outstanding disk input/output request; ticks while processing hard interrupts; tikes while processing soft interrupts; and ticks while involuntary waiting while the hypervisor is servicing another virtual processor. Refer to FIG. 8A for detail. The term “tick” means counter. Tick can count time, rounds, numbers, etc.

The Section 2 726 is shown in detail in 830 of FIG. 8A. As shown in FIG. 8A, Section 2 830 relates to network activities. Section 2 830 includes first 4 character of internet interface name; second 4 character of internet interface name; bytes received; packets received; bytes transmitted, and packets transmitted. Refer to FIG. 8A for detail.

The Section 3 728 is shown in detail in 840 of FIG. 8A. As shown in FIG. 8A, Section 3 840 relates to context switch. Section 3 840 includes count of processes and count of context switches.

The Section 4 730 is shown in detail in 850 of FIG. 8B. Section 4 850 relates to processing memory information. As shown in FIG. 8B, Section 4 includes amount of total memory available in kilobytes; amount of free memory in kilobytes; available memory in kilobytes (An estimate of the amount of memory available for user-space allocations without causing swapping); amount of memory used as buffers by the kernel in kilobytes; amount of memory used to cache data by the kernel in kilobytes; amount of memory in kilobytes needed for current workload (This is an estimate of how much RAM/swap is needed to guarantee that there never is out of memory); the total amount of buffer or page cache memory, that is active in kilobytes (This part of the memory is used recently and usually not reclaimed unless absolutely necessary); and the total amount of buffer or page cache memory that are free and available in kilobytes (This is memory that has not been recently used and can be reclaimed for other purposes by the paging algorithm).

The Section 5 732 is shown in detail in 860 of FIG. 8B. As shown in FIG. 8B, the section 5 860 relates to swap. Section 5 860 includes amount of total swap space in kilobytes; and amount of free swap space in kilobytes.

The Section 6 734 is shown in detail in 870 of FIG. 8B. As shown in FIG. 8B, the section 6 870 relates to paging. Section 6 870 includes the number of kilobytes the system has paged in from disk; the number of kilobytes the system has paged out to disk; number of page faults (major+minor) made by the system (This is not a count of page faults that generate I/O, because some page faults can be resolved without I/O.); number of major thrifts the system has made, those which have required loading a memory page from disk; and count of pages that have been freed.

The Section 7 736 is shown in detail in 880 of FIG. 8B. Section 7 880 relates to input-output (Per IO device (13 words * 24 IFACEs). includes both raw and cooked partitions). Section 7 880 includes first 4 chars of IO device name; second 4 chars of IO device name; reads completed successfully; reads merged; sectors read; time spent reading (ms); writes completed; writes merged; sectors written; time spent writing (ms); I/Os currently in progress; time spent doing I/Os (ms); and weighted time spent doing I/Os (ms).

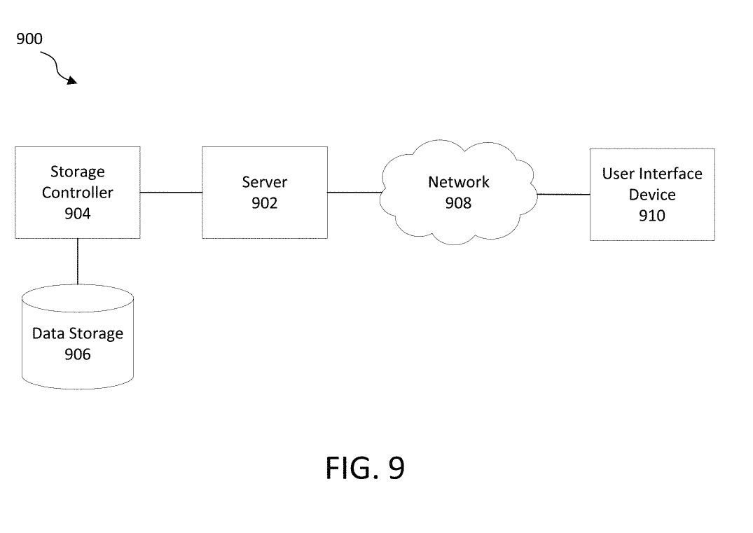

FIG. 9 illustrates a computer network 900 for obtaining access to database files in a computing system according to one embodiment of the disclosure. The computer network 900 may include a server 902, a data storage device 906, a network 908, and a user interface device 910. The server 902 may also be a hypervisor-based system executing one or more guest partitions hosting operating systems with modules having server configuration information. In a further embodiment, the computer network 900 may include a storage controller 904, or a storage server configured to manage data communications between the data storage device 906 and the server 902 or other components in communication with the network 908. In an alternative embodiment, the storage controller 904 may be coupled to the network 908.

In one embodiment, the user interface device 910 is referred to broadly and is intended to encompass a suitable processor-based device such as a desktop computer, a laptop computer, a personal digital assistant (PDA) or tablet computer, a smartphone or other mobile communication device having access to the network 908. In a further embodiment, the user interface device 910 may access the Internet or other wide area or local area network to access a web application or web service hosted by the server 902 and may provide a user interface for enabling a user to enter or receive information.

The network 908 may facilitate communications of data between the server 902 and the user interface device 910. The network 908 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate.

In one embodiment, the user interface device 910 accesses the server 902 through an intermediate sever (not shown). For example, in a cloud application the user interface device 910 may access an application server. The application server fulfills requests from the user interface device 910 by accessing a database management system (DBMS). In this embodiment, the user interface device 910 may be a computer or phone executing a Java application making requests to a JBOSS server executing on a Linux server, which fulfills the requests by accessing a relational database management system (RDMS) on a mainframe server.

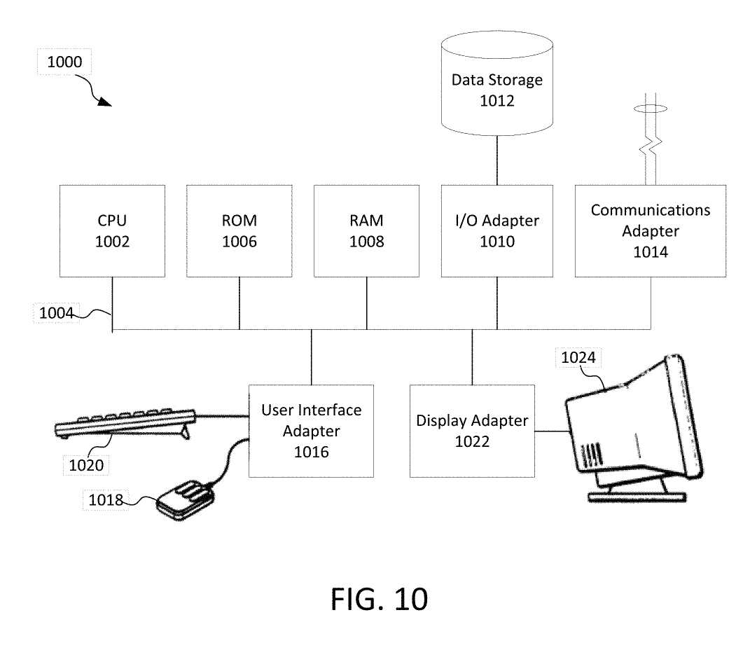

FIG. 10 illustrates a computer system 1000 adapted according to certain embodiments of the server 1002 and/or the user interface device 1010. The central processing unit (“CPU”) 1002 is coupled to the system bus 1004. The CPU 1002 may be a general purpose CPU or microprocessor, graphics processing unit (“GPU”), and/or microcontroller. The present embodiments are not restricted by the architecture of the CPU 1002 so long as the CPU 1002, whether directly or indirectly, supports the operations as described herein. The CPU 1002 may execute the various logical instructions according to the present embodiments.

The computer system 1000 may also include random access memory (RAM) 1008, which may be synchronous RAM (SRAM), dynamic RAM (DRAM), synchronous dynamic RAM (SDRAM), or the like. The computer system 1000 may utilize RAM 1008 to store the various data structures used by a software application. The computer system 1000 may also include read only memory (ROM) 1006 which may be PROM, EPROM, EEPROM, optical storage, or the like. The ROM may store configuration information for booting the computer system 1000. The RAM 1008 and the ROM 1006 hold user and system data, and both the RAM 1008 and the ROM 1006 may be randomly accessed.

The computer system 1000 may also include an I/O adapter 1010, a communications adapter 1014, a user interface adapter 1016, and a display adapter 1022. The I/O adapter 1010 and/or the user interface adapter 1016 may, in certain embodiments, enable a user to interact with the computer system 1000. In a further embodiment, the display adapter 1022 may display a graphical user interface (GUI) associated with a software or web-based application on a display device 1024, such as a monitor or touch screen.

The I/O adapter 1010 may couple one or more storage devices 1012, such as one or more of a hard drive, a solid state storage device, a flash drive, a compact disc (CD) drive, a floppy disk drive, and a tape drive, to the computer system 1000. According to one embodiment, the data storage 1012 may be a separate server coupled to the computer system 1000 through a network connection to the I/O adapter 1010. The communications adapter 1014 may be adapted to couple the computer system 1000 to the network 908, which may be one or more of a LAN, WAN, and/or the Internet. The user interface adapter 1016 couples user input devices, such as a keyboard 1020, a pointing device 1018, and/or a touch screen (not shown) to the computer system 1000. The display adapter 1022 may be driven by the CPU 1002 to control the display on the display device 1024. Any of the devices 1002-1022 may be physical and/or logical.

The applications of the present disclosure are not limited to the architecture of computer system 1000. Rather the computer system 1000 is provided as an example of one type of computing device that may be adapted to perform the functions of the server 902 and/or the user interface device 910. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 1300 may be virtualized for access by multiple users and/or applications.

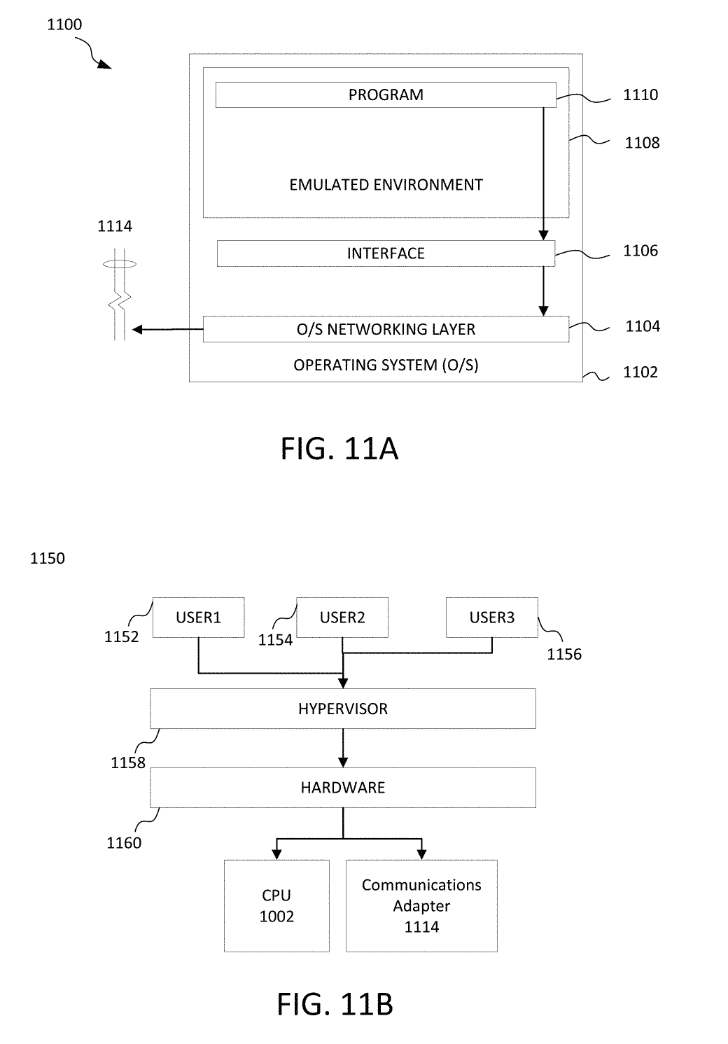

FIG. 11A is a block diagram illustrating a server 1100 hosting an emulated software environment for virtualization according to one embodiment of the disclosure. An operating system 1102 executing on a server 1100 includes drivers for accessing hardware components, such as a networking layer 1104 for accessing the communications adapter 1114. The operating system 1102 may be, for example, Linux or Windows. An emulated environment 1108 in the operating system 1102 executes a program 1110, such as Communications Platform (CPComm) or Communications Platform for Open Systems (CPCommOS). The program 1110 accesses the networking layer 1104 of the operating system 1102 through a non-emulated interface 1106, such as extended network input output processor (XNIOP). The non-emulated interface 1106 translates requests from the program 1110 executing in the emulated environment 1108 for the networking layer 1104 of the operating system 1102.

In another example, hardware in a computer system may be virtualized through a hypervisor. FIG. 11B is a block diagram illustrating a server 1150 hosting an emulated hardware environment according to one embodiment of the disclosure. Users 1152, 1154, 1156 may access the hardware 1160 through a hypervisor 1158. The hypervisor 1158 may be integrated with the hardware 1160 to provide virtualization of the hardware 1160 without an operating system, such as in the configuration illustrated in FIG. 14A. The hypervisor 1158 may provide access to the hardware 1160, including the CPU 1002 and the communications adaptor 1114.

If implemented in firmware and/or software, the functions described above may be stored as one or more instructions or code on a computer-readable medium. Examples include non-transitory computer-readable medium encoded with a data structure and computer-readable medium encoded with a computer program. Computer-readable medium includes physical computer storage media. A storage medium may be any available medium that can be accessed by a computer. By way of example, and not limitation, such computer-readable medium can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable medium.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

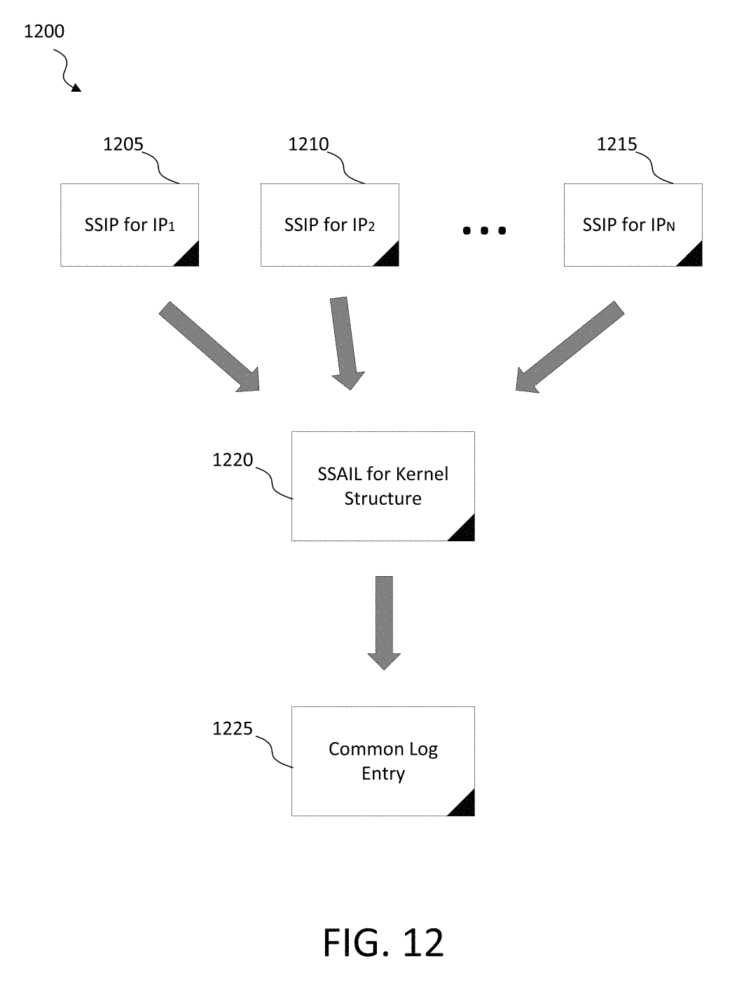

FIG. 12 shows a process 1200 of collecting information of a common log entry 1225 according to one embodiment of the disclosure. The process 1200 includes collecting information from a first IP₁ using instruction SSIP 1205. The process 1200 includes collecting information from a second IP₂ using instruction SSIP 1210. The process 1200 includes collecting information from an Nth IP_{N}, wherein N is a positive integer, using instruction SSIP 1215. The process 1200 further includes collecting information from the kernel structure using SSAIL 1220. The SSAIL may include statistical information based on the SSIPs information. The process 1200 further includes assembling all of the SSIPs information and SSAIL information into a single common log entry 1225.

In one embodiment, a single common log entry may represent a poll cycle. The time duration of a poll cycle may be configurable. In one embodiment, a poll cycle is 1 second. In another embodiment, the poll cycle can be from 0.1 second to 10 second.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A computing system configured to optimize computing resources distribution, comprising
a hardware platform, the hardware platform including a physical instruction processor (IP);
a kernel structure executed on the hardware platform, the kernel structure including an emulated IP;
an emulated operating system executed on the kernel structure; and
a performance monitor executed on the emulated operating system;
wherein the performance monitor interrogates the emulated IP to obtain performance information, the performance information including
a time of executing an instruction at the kernel structure;
a time of executing an instruction at an application software level;
bytes received by the emulated IP through a networking interface; and
bytes transmitted by the emulated IP through the networking interface.

2. The computing system according to claim 1, the performance information further including
an amount of total memory available; and
an amount of free memory available.

3. The computing system according to claim 1, the performance information further including
an amount of memory used as buffers by the kernel structure; and
an amount of memory used as cache by the kernel structure.

4. The computing system according to claim 1, the performance information further including
an amount of memory need for current workload.

5. The computing system according to claim 1, the performance information further including
a number of memory the computing system has paged in from a disk; and
a number of memory that computing system has paged out to a disk.

6. The computing system according to claim 1, the performance information further including
whether a read is completed;
a time spent by the emulated IP on the read;
whether a write is completed; and
a time spent by the emulated IP on the write.

7. The computing system according to claim 1, further including
a commodity OS, wherein the emulated OS is executed within the commodity OS.

8. The computing system according to claim 1, wherein the emulated IP is executed only on the physical IP.

9. The computing system according to claim 9, wherein the physical IP hosts another emulated IP.

10. The computing system according to claim 1, further including
a compiler that translates instruction execution counts of the emulated IP to instruction execution counts of the physical IP.

11. A computer program product configured to optimize computing resources distribution, comprising:
a hardware platform, the hardware platform including a physical instruction processor (IP) and a non-transitory computer-readable medium;
a kernel structure executed on the hardware platform, the kernel structure including an emulated IP; and
an emulated operating system executed on the kernel structure; and
the non-transitory computer-readable medium comprising instructions which, when executed by the emulated IP, cause the emulated IP to send performance information to the computer program, the performance information including
a time of executing an instruction at the kernel structure;
a time of executing an instruction at an application software level;
bytes received by the emulated IP through a networking interface; and
bytes transmitted by the emulated IP through the networking interface.

12. The computer program product of claim 11, the performance information further including
an amount of total memory available; and
an amount of free memory available.

13. The computer program product of claim 11, the performance information further including
an amount of memory used as buffers by the kernel structure; and
an amount of memory used as cache by the kernel structure.

14. The computer program product of claim 11, the performance information further including
an amount of memory need for current workload.

15. The computer program product of claim 11, the performance information further including
a number of memory the computer program product has paged in from a disk; and
a number of memory the computer program product has paged out to a disk.

16. The computer program product of claim 11, the performance information further including
whether a read is completed;
a time spent by the emulated IP on the read;
whether a write is completed; and
a time spent by the emulated IP on the write. 17. The computer program product of claim 11, further including
a commodity OS, wherein the emulated OS is executed within the commodity OS.

18. The computer program product of claim 11, wherein the emulated IP is executed only on the physical IP.

19. The computer program product of claim 18, wherein the physical IP hosts another emulated IP.

20. The computer program product of claim 11, further including
a compiler that translates instruction execution counts of the emulated IP to instruction execution counts of the physical IP.
